(19) United States
(12) Patent Application Publication
(10) Pub. No.: US 2003/0033390 A1
(43) Pub. Date: Feb. 13, 2003

(54) Program outputting method

(75) Inventors: Kei Yonezawa, Yokohama (JP); Kou Sugawara, Fujisawa (JP); Kazumi Rissen, Ebina (JP)

Correspondence Address: Townsend and Townsend and Crew LLP, 8th Floor, Two Embarcadero Center, San Francisco, CA, 94111, US

(73) Assignee: Hitachi, Seisakusho Corp., Ltd., Tokyo (JP)

(21) Appl. No.: 10/123,347

(22) Filed: Apr. 16, 2002

(30) Foreign Application Priority Data
Aug. 9, 2001 (JP) 2001-241595

(51) Int. Cl. G06F 15/177; G06F 15/16

(52) U.S. Cl. 709/220; 709/203

(57) ABSTRACT

A program distribution system includes a program transmitting device configured to transmit a program content to a remote location. A viewer terminal device is configured to receive the transmitted program content and output the content to a display. The viewer terminal device is further configured to provide a viewer with a choice of viewing the content in a first viewing setting or a second viewing setting. The first viewing setting displays one or more commercials at predetermined time intervals. The second viewing setting displays the one or more commercials at different times than the predetermined time intervals.

### CROSS-REFERENCES TO RELATED APPLICATIONS

The present application is related to and claims priority from Japanese Patent Application No. 2001-241595, filed on Aug. 9, 2001, which is incorporated by reference herein for all purposes.

### BACKGROUND OF THE INVENTION

The present invention relates to a method for broadcasting program contents or distributing them over a network or the like.

Television and radio broadcast programs are generally supported with revenues from advertisements. While some viewer-paid channels or paid cable programs, exist, many people view free broadcasts in which commercials are displayed with programs.

With conventional analog broadcasts, contents could only be broadcast and viewed one at a time. However, with digital broadcasts, commercials for different products or with different content can be provided according to viewer attributes, e.g., family-oriented/individual-oriented, age groups, and the like. However, the broadcast schedule for programs and commercials are generally fixed, and the format of inserting commercials into programs remains unchanged.

Commercials are provided at fixed positions or time intervals even for paid cable programs. For example, in Japanese laid-open patent publication number Hei 9-18850, entitled “Multimedia communication system and communication device, a system is presented in which fees are reduced when a selection is made to view with commercials.

Since many programs produced are not specifically tailored for insertion of commercials, their insertion during broadcast can degrade the viewing experience of the program. For example, in a sports broadcast, the game cannot be played to suit the broadcast. Thus interesting or points-scoring plays that take place during commercial breaks may be missed. For movies produced for theatrical release, the insertion of commercials can destroy the continuity or change the intended effect of the movie, e.g., dramatic tension can be lost due to a commercial break.

Also, channel surfing by the viewer when a commercial is being aired can be a significant loss to for the station and the program sponsor.

Therefore, it would be desirable to provide a program distribution method that distributes a television program to a viewer without reducing viewer experience due to commercials. It would also be desirable to provide a program distribution method that provide viewers with an incentive for viewing commercials, thereby increase viewing rates for commercials.

### BRIEF SUMMARY OF THE INVENTION

The present invention relates to a method for outputting programs in a program distribution system. An embodiment of the present invention includes a program transmitting device transmitting program content; a viewer terminal device receiving and outputting the transmitted program content; and a program transmission path connecting the program transmitting device and the viewer terminal device. In the viewer terminal device, an output of program content is changed after a predetermined time based on an output status of a predetermined program content during a predetermined time interval.

According to another embodiment of the present invention, a method for outputting programs in a program distribution system includes a program transmitting device transmitting program content; a viewer terminal device receiving and outputting the transmitted program content; and a program transmission path connecting the program transmitting device and the viewer terminal device, wherein the method for outputting programs includes a step for transmitting a first program content from the program transmitting device; a step for recording an output status of the first program content in the viewer terminal device receiving and outputting the first program content; and a step for permitting the viewer terminal device to output a second program content if the output status satisfies a predetermined condition.

According to another embodiment of the present invention, a method for outputting programs in a program distribution system includes a program transmitting device transmitting program content; a viewer terminal device receiving and outputting the transmitted program content; and a program transmission path connecting the program transmitting device and the viewer terminal device, wherein the step for outputting programs includes a step for sending a first program content from the program transmitting device, a service usage condition indicating an output status condition for the first program content that must be met to permit viewing of a second program content, and an identifier indicating the second program content to be viewed if the service usage condition is met, a step for recording in the viewer terminal device the first program content, an output status of the first program content, and a step for permitting the viewer terminal device to output the second program content indicated by the identifier when the output status meets the service usage condition.

According to another embodiment of the present invention, a method for outputting programs as described above, wherein when outputting program content for which the output status is to be evaluated, associated coupon information is recorded, and output status for the program content is evaluated using the coupon information.

According to another embodiment of the present invention, a method for outputting programs in a program distribution system includes a program transmitting device transmitting a program content; a viewer terminal device receiving and outputting the transmitted program content; and a program transmission path connecting the program transmitting device and the viewer terminal device, wherein the step for outputting programs includes a step for transmitting a first program content from the program transmitting device, a step for storing coupon information for a value corresponding to an output status of the first program content in the viewer terminal device, and a step for permitting output of the second program content by the viewer terminal device by subtracting a coupon information value needed to view the second program content from the stored coupon information value.

According to another embodiment of the present invention, a method for outputting programs as described above wherein broadcast waves are used as the program transmission path and an output status for a predetermined channel in the viewer terminal device is used as the output status for the predetermined program content.

According to another embodiment of the present invention, a method for outputting programs as described above wherein a communication line is used as the program transmission path.

According to another embodiment of the present invention, a method for outputting programs as described above wherein the program content for which the output status is to be evaluated is commercial information.

According to another embodiment of the present invention, a method for outputting programs as described above wherein a time interval during which the output status of the program content is recorded is formed from a plurality of non-continuous time intervals.

According to another embodiment of the present invention, a method for outputting programs as described above wherein an output time for the second program content is determined according to an output size of program content for which the output status is to be evaluated.

According to another embodiment, a method for outputting programs as described above wherein content for receiving viewer input is included in the program content for which the output status is to be evaluated, the information being used to evaluate the output status of the program content.

According to yet another embodiment, a program distribution system includes a program transmitting device configured to transmit a program content to a remote location. A viewer terminal device is configured to receive the transmitted program content and output the content to a display. The viewer terminal device is further configured to provide a viewer with a choice of viewing the content in a first viewing setting or a second viewing setting. The first viewing setting displays one or more commercials at predetermined time intervals. The second viewing setting displays the one or more commercials at different times than the predetermined time intervals.

### BRIEF DESCRIPTION OF THE DRAWINGS

FIG. 1 shows a block diagram of an architecture of an on-demand program distribution system according to a first embodiment of the present invention.

FIG. 2 shows a simplified drawing for the purpose of describing an example of a program distribution service according to the first embodiment of the present invention.

FIG. 3 shows a flowchart of operations performed for switching program display according to the first embodiment of the present invention.

FIG. 4 shows a flowchart of operations performed to record output status of commercials associated with a program service for which display switching is to be performed.

FIG. 5 shows a drawing of an example of a commercial output information table structure recorded in a commercial output information storage module.

FIG. 6 shows a block diagram of an architecture of a video distribution system based on broadcasting according to a second embodiment of the present invention.

FIG. 7 shows a simplified drawing for the purpose of describing an example of a program distribution service according to the second embodiment of the present invention.

FIG. 8 shows a drawing of an example of a screen used to confirm usage of commercial coupons.

FIG. 9 shows a flowchart of operations performed to switch program display using commercial coupons.

FIG. 10 shows a drawing of an example of coupon usage information sent from a program distribution server during a display switching operation.

FIG. 11 shows a flowchart of an example of a flow of operations performed to obtain coupon points used in the second embodiment of the present invention.

FIG. 12 a drawing of an example of commercial coupon information used in obtaining coupons.

### DETAILED DESCRIPTION OF THE INVENTION

This embodiment presents an example in which a network is used as a program distribution path. When a viewer terminal accesses a program distribution server via a network, video and audio streams are sent. The program distribution server stores and distributes program and advertisement data, and can also provide real-time distribution by using a live encoder to perform digitization. In the following example, a baseball game broadcast is being distributed live, and the viewer can be provided with a service in which commercials can be viewed all at once ahead of time so that the game can be watched without interruption. The encoded data are generally sent while they are being edited for insertion of commercials and the like. This embodiment provides a link or route for directly accessing unedited data as well as a link or route for sending commercials. When the viewer request a service, the viewer terminal automatically switches the access target to change commercial and programming displays.

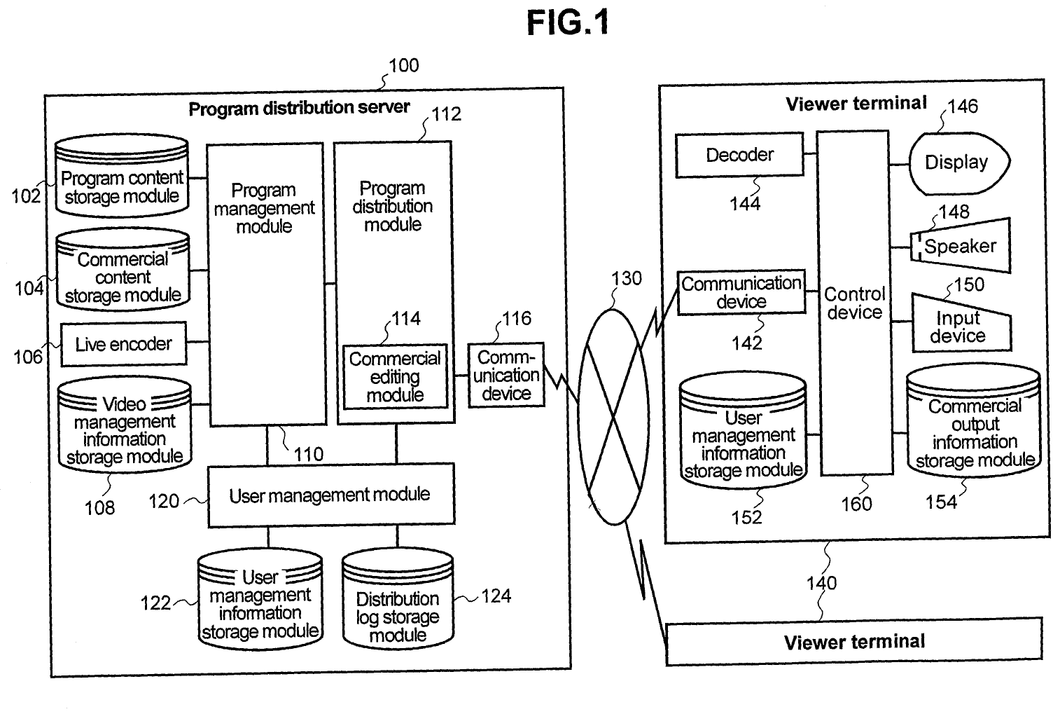

FIG. 1 is a block diagram showing the architecture of an on-demand program distribution system according to this embodiment of the present invention. FIG. 1 shows a program distribution server 100, a viewer terminal 140, and a communication network 130 that connects these elements.

In the program distribution server 100, a program management module 110 handles the video data stored in a program content storage module 102 and a commercial content storage module 104 as well as video data that has been encoded real-time by a live encoder 106. A program distribution module 112 communicates with the viewer terminal 140 via a communication device 116 to send programs. During this process, a commercial editing module 114 inserts commercial video into the program sent when necessary. Program distribution schedules and information relating to video data management are stored in a video management information storage module 108. This information may also be sent as additional information when necessary. Also, a user management module 120 manages user management information stored in a user management information storage module 122 and a distribution log stored in a distribution log storage module 124. The user management information storage module 122 stores user management information relating to users receiving program distribution services. The distribution log storage module 124 stores a distribution log that records video distribution conditions.

In the viewer terminal 140, programs received by the communication device 142 are decoded by a decoder 144. Video is output via a display 146, and audio is output via a speaker 148. The viewer uses an input device 150 to select programs and request services.

A user management information storage module 152 stores user information used to manage the viewer terminal 140. A commercial output information storage module 154 stores information relating to output conditions for commercials. A control device 160 controls these elements and performs processing to receive and display video.

A network 130 can be a public network if services are offered to the general public, a local network such as a LAN if services are offered to a specific area, a CATV network, or the like. Also, wireless communication can be used if adequate performance can be provided.

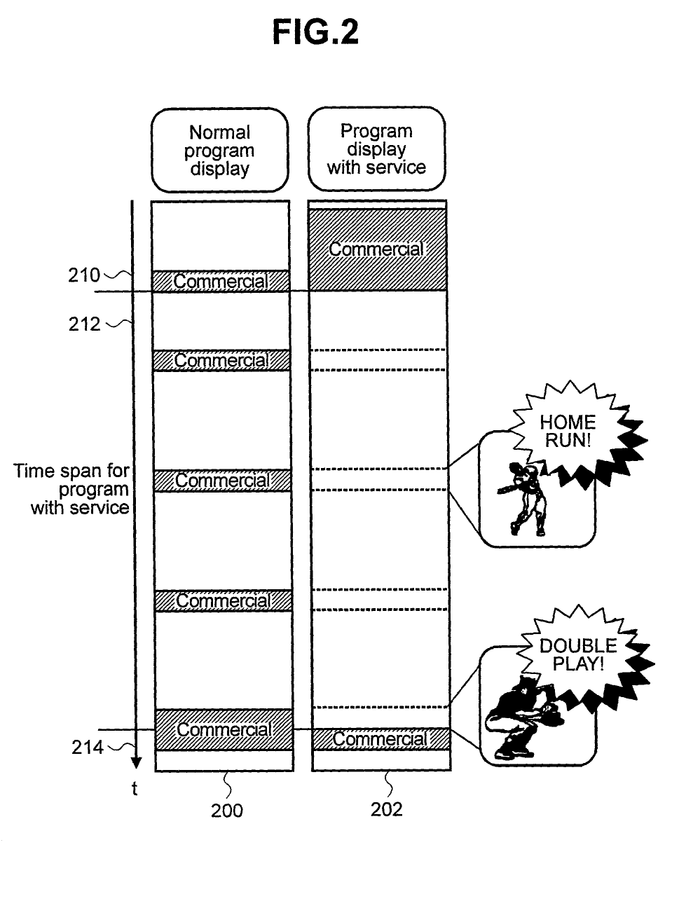

FIG. 2 is a simplified drawing for the purpose of describing an example of a program distribution service that makes use of the present embodiment.

In FIG. 2, a timeline 200 and a timeline 202, respectively, show the changes over time in program output for standard programming and for programming provided by a service based on this embodiment. A time span 210 precedes the start of transmission of the program with the service. The program with the service is distributed during a time span 212.

A time span 214 follows the end of program transmission. In the standard programming shown in the timeline 200, commercials are broadcast in the middle of the program and output from the viewer terminal. With the service offered in the timeline 202, on the other hand, commercials from program sponsors are transmitted all at once and output from the viewer terminal before the start of transmission of the program. Then, the uncut broadcast is displayed on the terminal on which the commercials were displayed. After the transmission of this program, programs are displayed in the standard way.

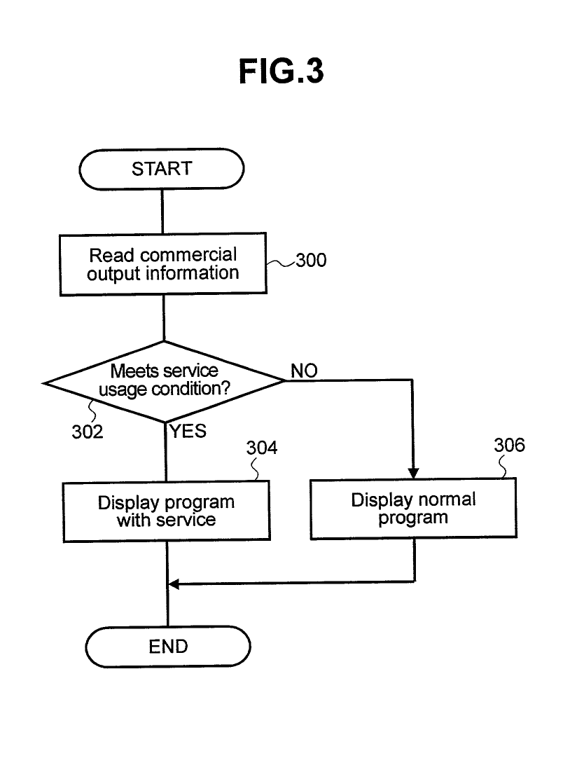

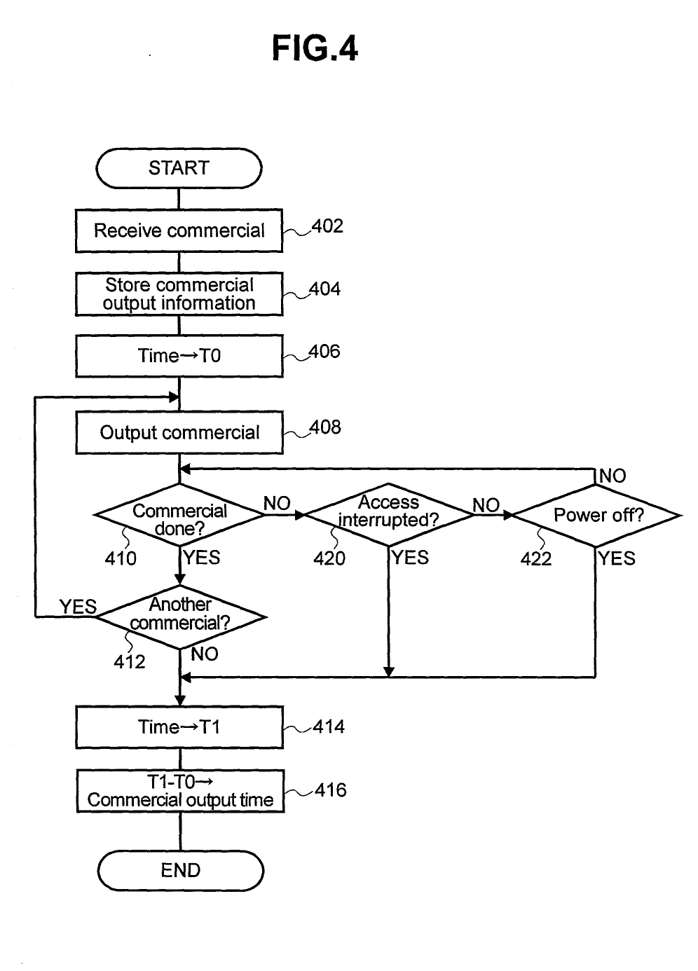

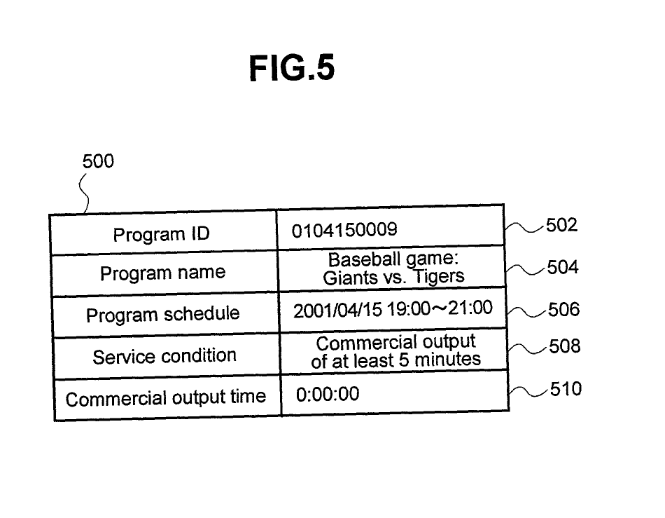

FIG. 3 is a flowchart showing the operations performed by the viewer terminal 140 to switch programming display as in the timeline 202 when service usage conditions are met. FIG. 4 is a flowchart showing the operations performed by the viewer terminal 140 to record output status of commercials corresponding to the programming service for which display switching is performed. FIG. 5 shows a sample table structure for commercial output information stored in the commercial output information storage module 154 by the recording operations from FIG. 4. First, the table structure from FIG. 5 will be described.

In FIG. 5, commercial output information 500 is stored in the commercial output information storage module 154. A program ID 502, a program name 504, and a program schedule 506 are fields whereon various information relating to a program is stored. The program ID 502 contains information to identify a program. The program name 504 contains a program name. The program schedule 506 contains a program transmission schedule. In this embodiment, programs to be transmitted are managed using a unique program ID assigned to each program. When a program or a commercial associated with a program is transmitted, additional information including the program ID is also sent. Service usage conditions 508 stores conditions for the application of services when displaying the program. A commercial output time 510 contains the times at which commercials associated with the program are to be output.

In this embodiment, programs for which the service can be applied are announced ahead of time. If the viewer makes an on-line request, commercials associated with the program are transmitted. Referring to the flowchart in FIG. 4, the operations performed by the viewer terminal 140 to record output conditions for commercials to the commercial output information storage module 154 in the form of the commercial output information 500 will be described.

When the viewer requests the service, commercials associated with the program service are transmitted to the viewer terminal 140 used to make the request (step 402). Since the program ID and the like for the program with the service is sent as additional information, a table for the commercial output information 500 is generated and information is stored (step 404). In this embodiment, the program ID 502, the program name 504, the program schedule 506, and the service usage conditions 508 are sent. The commercial output time 510 is initialized to 0. The current time is recorded as output start time T0 (step 406), and commercials are output using the display 146 and the speaker 148.

Since there can be more than one commercial, a determination is made as to whether one commercial has finished (step 410). If one commercial has finished, a determination is made as to whether there is a subsequent commercial (step 412). If a commercial for the same program service is transmitted, control goes back to step 408 and the commercial is output. The time at which the final commercial has finished is recorded as output end time T1 (step 414). T1−T0 is stored as the commercial output time in the commercial output time 510 of the commercial output information 500 (step 416).

If an event interrupts output of a commercial, the current time is immediately recorded as the output end time T1 (step 414), and T1−T0 is stored in the commercial output time 510 (step 416). In this embodiment, this can take place when a commercial is interrupted due to a loss of access to the program distribution server (step 420) or due to the power being turned off on the viewer terminal (step 422). In the operation shown in the flowchart in FIG. 4, commercials are output continuously. However, it is possible to have the output of commercials interrupted temporarily and resumed later. In such cases, it can be assumed that commercials are to be resumed if there is already commercial output information 500 with the program ID 502 identical to the ID of the requested program. The commercial output time 510 can be calculated by adding to the old value. Also, instead of calculating the output continuation time when commercials are being output, it would also be possible to record the commercial reception starting time, ending time, and times at which events, e.g., power being turned on or off, take place. Then, the commercial output time can be calculated when necessary.

In one implementation, viewers are asked to provide appropriate inputs while viewing the commercials to ensure that they are in fact viewing them rather than merely leaving the display device turned on without actually watching the commercials. The inputs may be made using a remote control, key board, voice recognition device, or other types of input devices. The viewer may be required to answer a simple question or press a particular button at a given time, or the like. The input may be required at the end of each segment of the commercials, or at regular or random intervals. If a viewer does not respond with a correct input, the commercial output time (T1−T0) may be adjusted accordingly.

Next, using the flowchart in FIG. 3, the operations performed to evaluate commercial output status and change the program output method will be described. When the start time for the program for which the service was requested arrives, the commercial output information 500 is read from the commercial output information storage module 154 (step 300), and an evaluation is made to determine if conditions for the use of the service are met (step 302). In this embodiment, the condition is whether commercials associated with the service have been output from the viewer terminal 140 for at least a predetermined time. If the commercial output time 510 meets the service usage condition 508, the service is used and the program is displayed (step 304). If the condition is not met, the program is displayed using the normal method (step 306).

As shown in FIG. 2, if a program is viewed without the use of this service (200), commercials will interrupt the program. For content that continues regardless of transmission circumstances, e.g., broadcasts of baseball games, interesting scenes that may take place during commercial time may be missed. By using this service to view the program (202) and viewing commercials all at once before the start of the program (210), the program (212) can be viewed without commercial interruptions. Thus, the program can be viewed in a leisurely manner without interruptions from commercials.

In this embodiment, all operations for recording commercial output status and for using services are performed by the viewer terminal 140. However, it would also be possible to have the program distribution server 100 handle information separately and select video for each individual viewer terminal.

In another embodiment, broadcasts are used as program distribution routes. Viewing credit or coupon information distributed with commercials is used to evaluate the output status. The terms “viewing credit” and “coupon” are used interchangeably. The viewer uses a program guide, remote control, or the like, to view commercials with coupons ahead of time. When a commercial is output at a predetermined time, the coupon output status is recorded in the form of coupon points. The coupon points can be added up so that the viewer can accumulate them as needed. Also, the viewer can use the accumulated points and select a program of interest out of a plurality of available programs for viewing with the service. Awarded points can be varied according to the length of the commercial output time, the time slot, and contents of the commercial. These conditions can be distributed ahead of time as part of the program guide. Alternatively, the information can be sent with each commercial. Of course, commercial coupons that can only be used for specific programs can also be issued.

In the following example, a service is provided in which, for a baseball game, the broadcast time can be extended past the normal broadcast ending time by using a commercial coupon. The offset in the broadcast time for the next program resulting from the extension of the broadcast time is adjusted by cutting out broadcasts of subsequent commercials. In this embodiment, programs with the service are broadcast on a channel separate from the channels broadcasting standard programming. Programming display can be switched by automatically selecting channels on the viewer terminal based on whether or not to use the service.

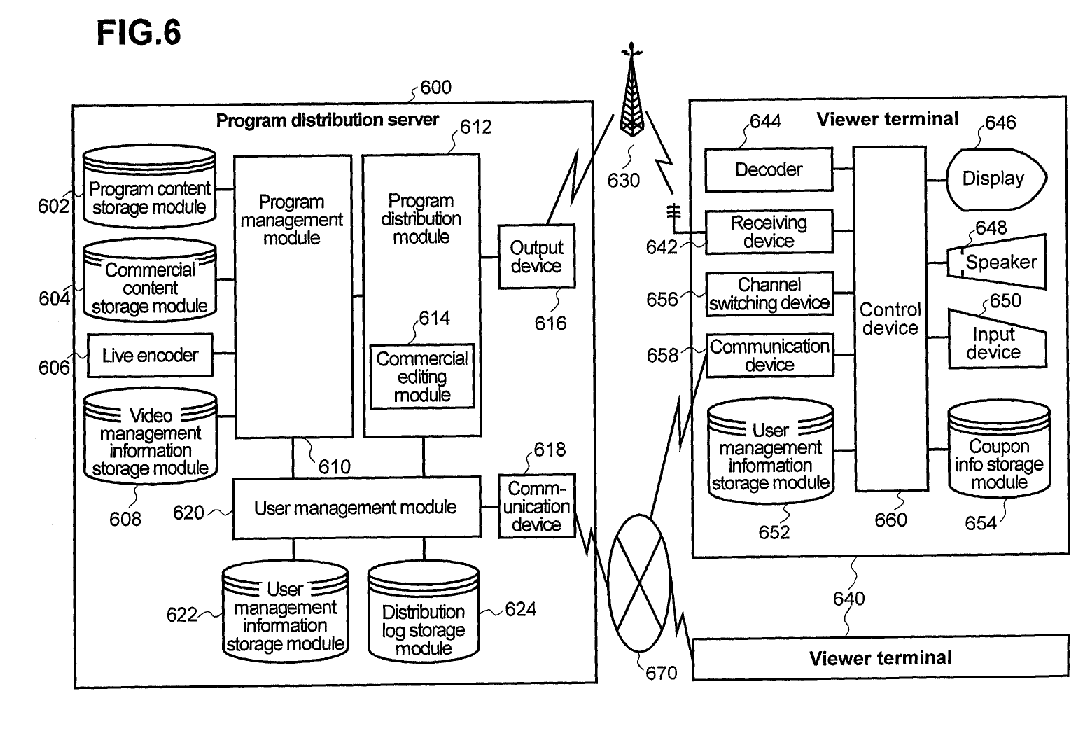

FIG. 6 is a block diagram of the functional architecture of a broadcast video distribution system according to the present embodiment.

FIG. 6 shows a program distribution server 600 of the broadcast station, a viewer terminal device 640, and broadcast equipment 630 for broadcasting programs from the broadcast station to the viewer. A communication network 670 connects the program distribution server 600 to the viewer terminal 640.

In the program distribution server 600, a program management module 610 manages video data stored in a program content storage module 602 and a commercial content storage module 604 as well as video data that has been encoded real-time by a live encoder 606. A program distribution module 612 uses a commercial editing module 614 to edit programming and commercials and generates the actual video to be broadcast. The video is sent from an output device 616 to the broadcast equipment 630.

A video management information storage module 608 stores information relating to the management of program distribution schedules and video data. When necessary, additional information is also included for information relating to commercial coupons and usage of coupons for programs.

A user management module 620 manages user management information stored in a user management information storage module 622 and distribution logs stored in a distribution log storage module 624. Also, if bi-directional services are to be provided, the user management module 620 uses a communication device 618 to communicate with each of the viewer terminals 640. The user management information storage module 622 stores information relating to users receiving the video distribution service. The distribution log storage module 624 stores distribution logs containing video distribution conditions.

In the viewer terminal 640, programs received by a receiving device 642 are decoded by a decoder 644. The video is output using a display 646, and the audio is output using a speaker 648. The viewer uses an input device 650 to select programs and request services. A user management information storage module 652 stores information used to manage the viewer terminal 640. A coupon information storage module 654 stores information relating to coupon points stored as a result of output of commercials with coupons. A channel selector device 656 normally selects a channel indicated by the viewer via the input device 650 from the received broadcast waves and displays it on the display 646. However, when the service of this embodiment is being used, the channel displaying the associated program is automatically selected and displayed on the display 646. Also, a communication device 658 communicates with the program distribution server 600 via the communication network 670 if the bi-directional service is being used. A control device 660 controls all these elements and performs video receiving and displaying operations.

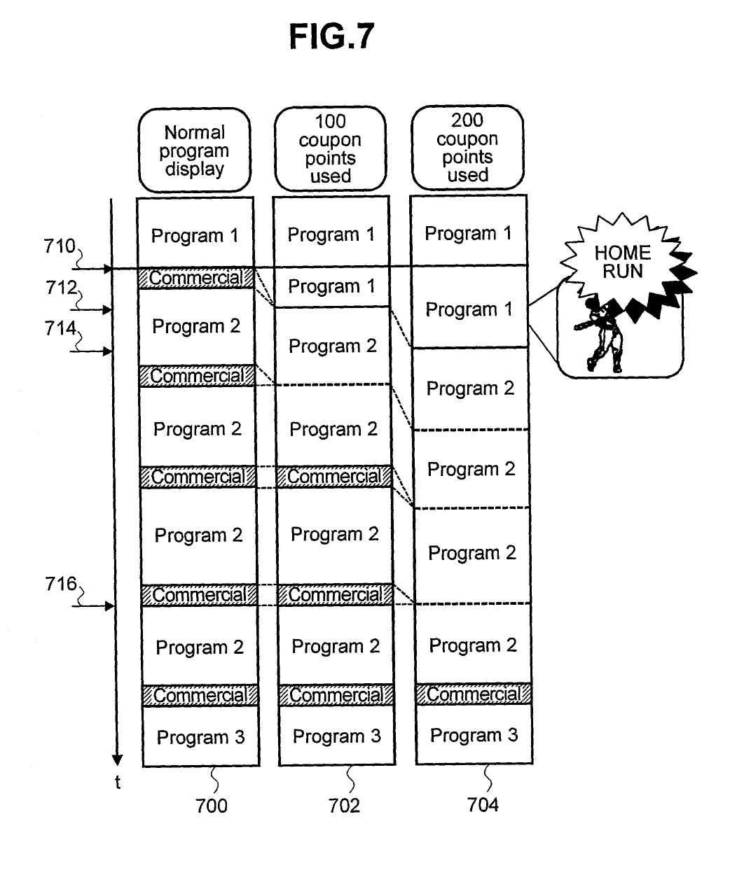

FIG. 7 is a simplified drawing for the purpose of describing an example of a program distribution service in which this embodiment is used.

In FIG. 7, a timeline 700, a timeline 702, and a timeline 704 are timelines indicating the changes in program output status over time for standard operations, for when the service is being used with 100 commercial coupon points, and for when the service is being used with 200 commercial coupon points, respectively. A time 710 is the program end time for the standard program display 700. A time 712 is the program end time for the program display 702 when 100 commercial coupon points are used. A time 714 is the program end time for the program display 704 when 200 commercial coupon points are used.

A time 716 is a point in time at which all three program contents become identical. In the timeline 700, when the planned broadcast end time 710 for a program 1 is reached, the broadcast of the program 1 is ended regardless of whether there is completion in the contents of the program being broadcast. In the timeline 702, when the planned broadcast end time 710 for the program 1 is reached, viewing time can be extended by a time corresponding to 100 commercial coupon points. Then, when the end time 712 is reached, the broadcast of the program 1 is stopped and broadcast of a subsequent program 2 is begun. The offset in the broadcast time of the program 2 caused by extending the prior broadcast is adjusted by cutting out broadcasts of subsequent commercials. In the timeline 704, viewing can be extended to the end time 714 of the program. When the end time 714 is reached, the broadcast of the program 1 is stopped and broadcast of the program 2 is started. Here also, the offset in broadcast time for the program 2 caused by the extension of the prior broadcast is adjusted by cutting out subsequent commercials. By making these adjustments, the contents of the programs output at the time 716 can all be identical.

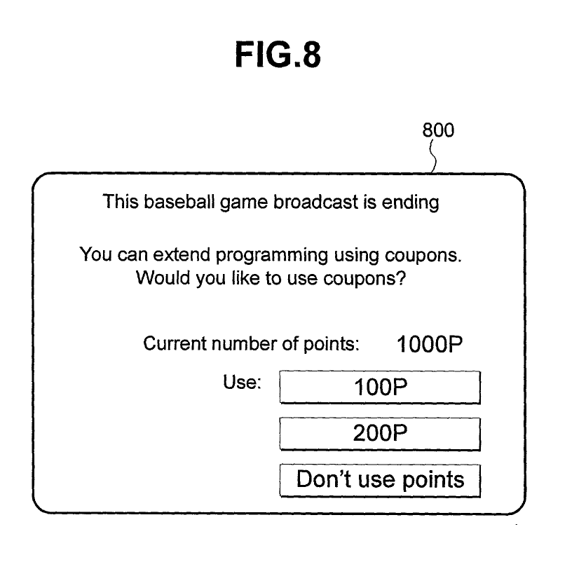

FIG. 8 is a drawing showing a sample screen used to confirm usage of commercial coupons. In FIG. 8, a screen 800 is displayed on the display 646 of the viewer terminal 640. The viewer looks at this screen 800 and uses the input device 650 to select a number of coupon points to be used when requesting the service.

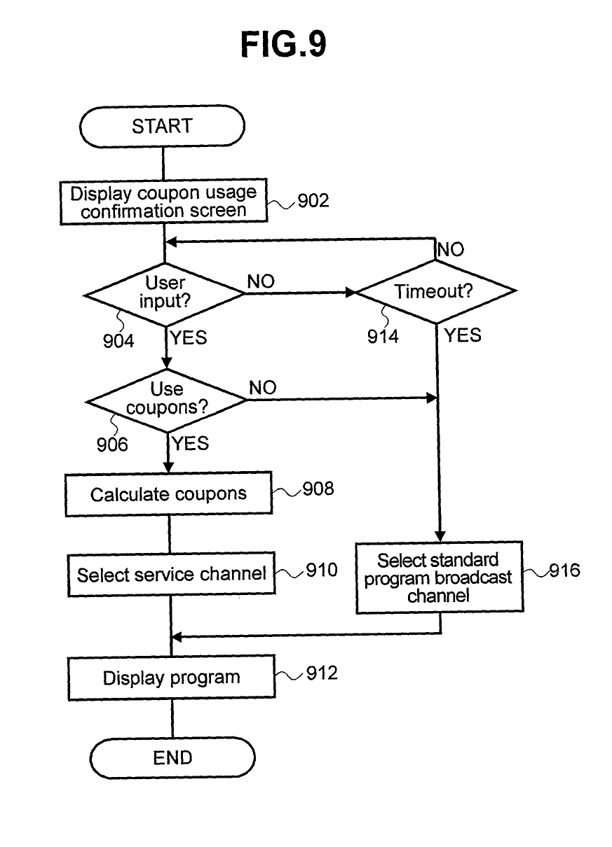

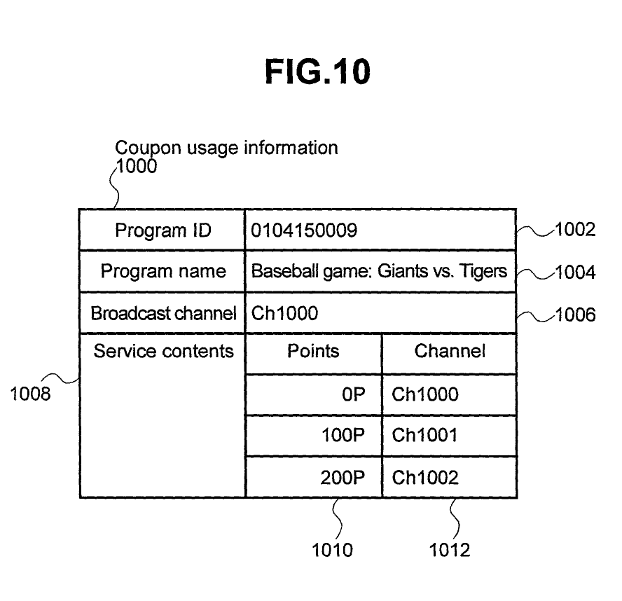

FIG. 9 is a flowchart showing the operations performed in the viewer terminal 640 when commercial coupons are used and program display switching is performed. FIG. 10 shows sample coupon usage information sent from the broadcast distribution server when this display switching operation is performed. First, the coupon usage information shown in FIG. 10 will be described.

FIG. 10 shows coupon usage information 1000. The coupon usage information 1000 includes information storage areas for a program ID 1002, a program name 1004, and a broadcast channel 1006. These fields 1002-1006 are used to store information relating to the program for which the service is to be used. The program ID 1002 stores a program ID used to identify a program. The program name 1004 stores a program name. The broadcast channel 1006 stores a broadcast channel. In this embodiment, the time span from the start to the end of service usage is separated, and both standard program display and display of the program with the use of the service are broadcast in parallel. A field 1008 includes a point usage field 1010 and a channel 1012 displaying the corresponding program.

Using the flowchart in FIG. 9 and the table in FIG. 10, the operations performed for switching program displays using commercial coupons will be described.

If the service is to be provided, a coupon usage confirmation screen is displayed on the viewer terminal 640 to allow the viewer to confirm the service offered and determine whether to use coupons (step 902). In this embodiment, when the baseball game program ends (the time 710 in FIG. 7), the screen 800 is displayed on the display 646. An indication of the viewers intentions via the input device 650 is awaited (step 904). When the viewer intention is indicated, a determination is made on whether or not to use coupons based on this (step 906). If coupons are to be used for the service, a predetermined number of coupon points is subtracted from the points recorded in the coupon information storage module 654 (step 908). The coupon usage information 1000 shown in FIG. 10 is looked up, and the channel selector device 656 switches to the channel indicated in the channel 1012 corresponding to the number of points 1010 to be used (step 910). The program is then displayed (step 912).

If there is no response regarding coupon usage for a fixed time after displaying of the screen 800 (step 914), it is assumed that the service will not be used and the channel for displaying the normal program is selected (step 916). In this case, the channel would be the channel associated with 0 points in the point usage field 1010 (channel 1000). The program is then displayed (step 912). Also, if the user indicates no coupon usage, (step 906), control proceeds to step 916.

Once the channels are all displaying the same contents (time 716 in FIG. 7), the channels for which coupons are used are automatically switched to the normal program channel at a suitable time. Usage of the service is then completed.

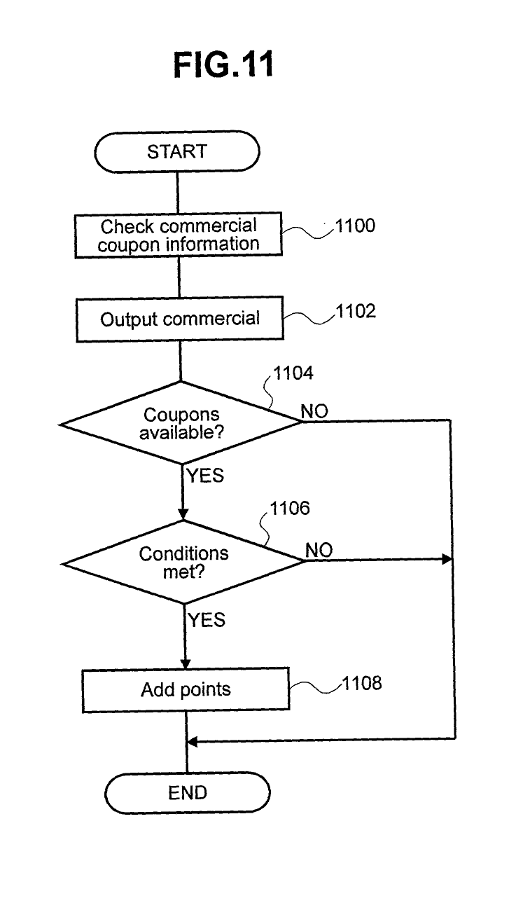

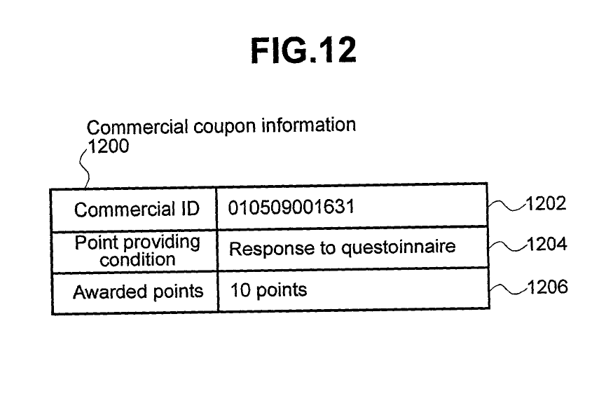

FIG. 11 is a flowchart showing a sample flow of operations performed in the viewer terminal 640 for obtaining coupon points used in this embodiment. FIG. 12 shows sample commercial coupon information used for obtaining coupons. This information is distributed along with commercials having coupons. First, the commercial coupon information shown in FIG. 12 will be described.

FIG. 12 shows commercial coupon information 1200. The commercial coupon information 1200 is formed from a commercial ID 1202 used to identify the commercial to which the coupon is attached, a point providing condition 1204 indicating the condition to be met to provide coupon points, and a point count 1206 to be added when the condition 1204 is met. In the example shown in FIG. 12, 10 points are provided when the viewer responds to a questionnaire indicated in the commercial. The point providing conditions can involve simply watching the commercial, of course, or can involve more active participation such as requesting information or registering for products. Conditions can also be combinations of these conditions. In this embodiment, only one set of conditions is involved, but more than one set of conditions can be made available so that, for example, simply viewing the commercial provides 1 point, responding to a questionnaire provides 5 points, and the like. In addition to questionnaires, points can be provided for taking a quiz or points can be provided according to the number of correct answers the viewer gives for a quiz.

Using the flowchart in FIG. 11, the flow of operations for obtaining coupon points will be described.

In the viewer terminal 640, when a commercial is received, the presence of commercial coupon information associated with the commercial is checked (step 1100). After outputting the commercial (step 1102), a determination is made as to whether a coupon is attached to the commercial (step 1104). If a coupon is attached, a determination is made as to whether the point providing condition 1204 is met (step 1106). If the point providing condition is met, the associated coupon point count 1206 is added to the viewer's accumulated points recorded in the coupon information storage module 654 (step 1208). If no coupon is attached to the commercial in step 1104 or if the condition is not met at step 1106, coupon points are not added and the operation is exited.

According to this embodiment, the use of the service (timelines 702, 704) allows viewing to be extended according to the number of coupons used compared to normal program display not involving the service (timeline 700). Thus, highlights and decisive moments in the game that take place after completion of the normal broadcast time can be viewed.

In the embodiment described above, available services are presented when normal programming ends (time 710). However, it would also be possible to display a coupon usage confirmation screen at the extension end time (time 712) corresponding to 100 coupon points so that another 100 points can be added to extend the service up to the end time 714 for the program.

Also, in the embodiment described above, the viewer terminal automatically switches channels. However, it would also be possible to scramble the channels involving coupons, with descrambling keys being sent only to users of coupons.

Furthermore, in the embodiment described above, output status for commercials broadcast separate from programs are recorded. However, it would also be possible to use a predetermined time within the broadcast of the program itself as a checkpoint at which to record output status so that subsequent program display contents can be changed.

In the embodiment described above, the described example involves viewing a sports program without commercials by viewing commercials at a predetermined time. However, it would also be possible to implement the present invention for interactive programs in which viewers make selections that change subsequent program content output.

The embodiments described above are provided merely as exemplary embodiments of the present invention. As such, they should not be used to limit the scope of the present invention. Rather the claims provided below should be used to interpret the scope of the present invention.

### LIST OF DESIGNATORS

100, 600: program distribution server

102, 602: program content storage module

104, 604: commercial content storage module

106, 606: live encoder

108, 608: live encoder

108, 608: video management information storage module

110, 610: program management module

112, 612: program distribution module

114, 614: commercial editing module

116, 142, 618, 658: commercial device

120, 620: user management module

122, 622: user management information storage module

124, 624: distribution log storage module

130, 670: commercial network

140, 640: viewer terminal device

144, 644: decoder

146, 646: display

148, 648: speaker

150, 650: input device

152, 652: user management information storage module

154: commercial output information storage module

160, 660: control device

616: transmitting device

630: broadcast equipment

642: receiving device

654: coupon information storage module

656: channel switching device

What is claimed is:

1. A program distribution system, comprising:
a program transmitting device configured to transmit a program content to a remote location; and
a viewer terminal device configured to receive the transmitted program content and output the content to a display, wherein the viewer terminal device is further configured to provide a viewer with a choice of viewing the content in a first viewing setting or a second viewing setting, the first viewing setting displaying one or more commercials at predetermined time intervals and the second viewing setting displaying the one or more commercials at different times than the predetermined time intervals.

2. The program distribution system of claim 1, wherein the one or more commercials are assigned to be displayed in connection with the program content, where the second viewing setting displays the one or more commercials before the program content is displayed.

3. The program distribution system of claim 2, further comprising:
an input device to input appropriate input while viewing the one or more commercials before the program content is displayed in order to obtain a commercial output time, wherein the commercial output time is an amount of commercial time credited to a viewer, so that the program content may be seen without commercial breaks for a given time according to the commercial output time.

4. The program distribution system of claim 2, wherein a viewer is required to provide appropriate inputs while viewing the one or more commercials before the program content is displayed to increase the commercial output time.

5. The program distribution system of claim 1, wherein the viewer terminal device including a memory storage location to store commercial output information.

6. The program distribution system of claim 5, wherein the commercial output information includes a commercial output time and program identification information, wherein the commercial output time corresponds to an amount of commercial time viewed before the program content by the viewer.

7. The program distribution system of claim 5, wherein the memory storage location of the viewer terminal device includes a viewing credit usage information segment having viewing credit points.

8. The program distribution system of claim 7, wherein the viewing credit points are obtained by viewing one or more commercials.

9. The program distribution system of claim 8, wherein the viewing credit points are accumulated according to an amount of time commercials have been viewed.

10. The program distribution system of claim 9, wherein a certain amount of viewing credit points is added for each time the viewer inputs an appropriate input at an appropriate time.

11. The program distribution system of claim 1, further comprising:
a memory storage location to store a commercial output time and program identification information, wherein the commercial output time corresponds to an amount of commercial time viewed before the program content by the viewer.

12. A method for outputting programs in a program distribution system, comprising:
transmitting a first program content to a remote location from a program transmitting device;
recording an output status of said first program content in a viewer terminal device configured to receive and output the first program content to a display; and
outputting a second program content from the viewer terminal device if the output status satisfies a predetermined condition.

13. The method of claim 12, wherein the output status for the program content is evaluated using viewing credit information.

14. A method for outputting programs in a program distribution system, comprising:
transmitting a first program content to a remote location from a program transmitting device;
storing viewing credit points corresponding to an output status of the first program content in a viewer terminal device configured to receive and output the first program content;
outputting a second program content from the viewer terminal device; and
subtracting one or more viewing credit points needed to view the second program content from the stored viewing credit points.

15. The method of claim 14, wherein an output status for a predetermined channel in the viewer terminal device is used as the output status for the predetermined program content.

16. The method of 14, wherein the program transmission device and the viewer terminal device are coupled to each other by a communication line.

17. The method of claim 14, wherein the program content for which the output status is evaluated is commercial information.

18. The method of claim 17, wherein a time interval during which the output status of the program content recorded is formed from a plurality of non-continuous time intervals.

19. The method of claim 14, wherein an output time for the second program content is determined according to an output size of a program content for which the output status is to be evaluated.

20. A method for outputting programs in a program distribution system, wherein the system includes a program transmitting device to transmit a program content and a viewer terminal device to receive and display the program content, the method comprising:
receiving a request to alter a predetermined commercial display setting from a viewer; and
displaying one or more commercials according to the request, so that the one or more commercial are displayed at different times than required by the predetermined commercial display setting.
